(19) United States
(12) Patent Application Publication
(10) Pub. No.: US 2026/0081170 A1
(43) Pub. Date: Mar. 19, 2026

(54) BLOCK COPOLYMER, CROSSLINKED BLOCK COPOLYMER COMPRISING BLOCK COPOLYMER, SULFUR-CARBON COMPOSITE, METHOD OF MANUFACTURING THE SULFUR-CARBON COMPOSITE

(71) Applicants: LG ENERGY SOLUTION, LTD, Seoul (KR); SEOUL NATIONAL UNIVERSITY R&DB FOUNDATION, Seoul (KR)

(72) Inventors: Soo-Hyun KIM, Daejeon (KR); Jong-Chan LEE, Seoul (KR); Ki-Hyun KIM, Daejeon (KR); Kwon-Nam SOHN, Daejeon (KR); Chan-Yeong KOONG, Seoul (KR); Da-Un JEONG, Seoul (KR); Dong-Gi HONG, Seoul (KR)

(21) Appl. No.: 19/101,869

(22) PCT Filed: Aug. 30, 2023
(86) PCT No.: PCT/KR2023/012932

§ 371 Date: Dec. 3, 2025

(30) Foreign Application Priority Data
Aug. 31, 2022 (KR) 10-2022-0110368

(51) Int. Cl. H01M 4/62; C08F 8/14; H01M 4/02; H01M 4/133; H01M 4/36; H01M 4/58; H01M 4/587; H01M 10/052

(52) U.S. Cl. CPC H01M 4/628; C08F 8/14; H01M 4/133; H01M 4/366; H01M 4/5815; H01M 4/587; H01M 10/052; C08F 2810/20; H01M 2004/028

(57) ABSTRACT

A sulfur-carbon composite of the present disclosure includes a crosslinked block copolymer, and the crosslinked block copolymer is manufactured from a block copolymer comprising a first block including a first repeating unit having a pyrene group at a terminal and a second block including a second repeating unit having a cationic functional group. As the crosslinked block copolymer is coated on the sulfur-carbon composite, it may be possible to prevent migration of lithium polysulfide leaking from a positive electrode of a lithium-sulfur battery to a negative electrode. Accordingly, it may be possible to prevent sulfur particle accumulation on lithium metal surface of the negative electrode, thereby maintaining charge/discharge capacity of the lithium-sulfur battery and improving battery life.

### CROSS-REFERENCE TO RELATED APPLICATIONS

The present application is a National Phase entry pursuant to 35 U.S.C. § 371 of International Application No. PCT/KR2023/012932, filed on Aug. 30, 2023, and claims the benefit of and priority to Korean Patent Application No. 10-2022-0110368, filed on Aug. 31, 2022, with the Korean Intellectual Property Office, the disclosures of which are incorporated herein by reference in their entirety for all purposes as if fully set forth herein.

### TECHNICAL FIELD

The present disclosure relates to a block copolymer capable of capturing polysulfide leaking out from a positive electrode to improve battery life and a secondary battery comprising the same.

### BACKGROUND

With the technology development and growing demand for mobile devices, there is a growing demand for secondary batteries as an energy source, and among secondary batteries, lithium secondary batteries are brought to market and being widely used due to high energy density and working potential, long cycle life and low self-discharge rate.

Recently, with the rising interest in environmental issues, many studies are being conducted on electric vehicles (EV) and hybrid electric vehicles (HEV) as an alternative to vehicles using fossil fuels such as gasoline vehicles and diesel vehicles that are regarded as one of the main causes of air pollution. Lithium secondary batteries having high energy density, high discharge voltage and output stability are mainly studied and used as a power source of electric vehicles and hybrid electric vehicles.

Lithium secondary batteries have a structure in which an electrode assembly includes a positive electrode and a negative electrode, each electrode including an electrode current collector and an active material coated on the electrode current collector, with a porous separator interposed between the positive electrode and the negative electrode, and a nonaqueous electrolyte comprising a lithium salt is wetted to the electrode assembly.

At the present time, the lithium secondary battery market is governed by technology based on pairing of lithium cobalt oxide LiCoO2 at the positive electrode and graphite at the negative electrode. The rated voltage of lithium secondary batteries is about 3.6V, while the rated voltage of most of other types of batteries (Ni—Cd, Ni-MH, etc.) is 1.5V. The energy density per volume and the energy density per mass are about 300 to 500 Wh/l and 160 to 200 Wh/kg, respectively. This value is the highest value among all the batteries now in the market. Additionally, this type of batteries has low self-discharge and long life (500 or 1000 cycles). Despite the surprising performance achievement, there is not much difference in performance between all the current lithium ion batteries, and it is foreseen that improvement will take place only to a very limited extent.

Accordingly, lithium-sulfur (Li—S) batteries are emerging as an alternative to the known lithium ion batteries.

In the same way as lithium ion secondary batteries, lithium-sulfur batteries work by lithium ions moving in the electrolyte between the positive electrode and the negative electrode. However, since lithium-sulfur batteries simply use sulfur, as opposed to lithium ion secondary batteries designed to store energy by intercalation reaction of lithium ions into molecules of the electrode active material, inducing changes in electrode structure, lithium-sulfur batteries work based on oxidation and reduction reaction between sulfur and lithium ions. Accordingly, compared to lithium ion secondary batteries, lithium-sulfur batteries may have theoretically higher capacity at the equal volume without limitations on the electrode structure. Due to this feature, in lithium-sulfur batteries comprising the sulfur positive electrode and the lithium metal negative electrode, when it is assumed that elemental sulfur (Ss) having ring structure is completely reduced to lithium polysulfide (Li₂S), the theoretical capacity is 1,675 mAh/g and the theoretical energy density is 2,600 Wh/kg that are higher 3 times to 6 times than the existing other battery systems (Ni/MH batteries: 450 Wh/kg, Li/FeS: 480 Wh/kg, Li/MnO2: 1,000 Wh/kg, Na/S: 800 Wh/kg).

On the other hand, the existing transition metal oxide based lithium ion secondary batteries may be thought to be batteries comprising materials that are the sources of heavy metal contamination since they comprise oxides of nickel (Ni), cobalt (Co) and manganese (Mn) having higher density than the density of heavy metal (5 g/mL or more of metal) in the positive electrode. However, lithium-sulfur batteries are free of materials causing contamination and comprise nontoxic materials, and from this perspective, they are considered to be eco-friendly. Additionally, the positive electrode material, sulfur, is abundant on Earth and inexpensive.

Meanwhile, in lithium-sulfur batteries, reduction reaction of sulfur and oxidation reaction of lithium metal occurs during discharging, and in this instance, sulfur forms lithium polysulfide (LiPS) of linear structure from S₈ of ring structure, and lithium-sulfur batteries show stepwise discharge voltage until the lithium polysulfide is completely reduced to Li₂S. However, while lithium-sulfur batteries are charged/discharged, charge/discharge efficiency reduces and battery life degrades. As described above, life degradation of lithium-sulfur batteries is caused by many different factors such as side reaction of electrolyte solutions, instability of lithium metal, and accumulation of positive electrode by-products (for example, dissolution of lithium polysulfide from the positive electrode).

That is to say, in lithium-sulfur batteries using the sulfur based compound for the positive electrode active material and alkaline metal such as lithium for the negative electrode active material, dissolution of lithium polysulfide occurs during charging/discharging, and the lithium polysulfide leaking from the positive electrode migrates to the negative electrode, which reduces the capacity of the lithium-sulfur batteries and shortens the life of the lithium-sulfur batteries. That is to say, since the lithium polysulfide leaking from the positive electrode has high solubility in the electrolyte solution, the lithium polysulfide may unintentionally migrate to the negative electrode through the separator via the electrolyte solution, causing irreversible loss of the positive electrode active material and the consequential capacity fading, and sulfur particle accumulation on lithium metal surface induced by side reaction, resulting in shorter battery life.

To solve the life reduction problem caused by lithium polysulfide, in the technical field, studies have been conducted on the addition of reaction mitigating materials to the negative electrode to prevent side reaction on lithium metal surface, but did not produce meaningful outcomes.

The background description provided herein Is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

### Technical Problem

An embodiment of the present disclosure is directed to providing a block copolymer capable of capturing lithium polysulfide leaking from a positive electrode to improve the life of a lithium-sulfur battery.

Another embodiment of the present disclosure is directed to providing a crosslinked block copolymer manufactured by polymerization of the block copolymer.

Another embodiment of the present disclosure is directed to providing a sulfur-carbon composite capable of capturing lithium polysulfide leaking from the positive electrode to improve the life of a lithium-sulfur battery.

Another embodiment of the present disclosure is directed to providing a method of manufacturing the sulfur-carbon composite.

### Technical Solution

To solve the above-described problem of the present disclosure, there are provided a block copolymer, a crosslinked block copolymer comprising the block copolymer, a sulfur-carbon composite and a method of manufacturing a sulfur-carbon composite according to the following embodiments.

According to a first embodiment, there is provided the block copolymer, comprising a first block comprising a first repeating unit having a pyrene group at a terminal; and a second block comprising a second repeating unit having a cationic functional group.

According to a second embodiment, in the first embodiment, a mole ratio of the first block to the second block may be 1:99 to 99:1.

According to a third embodiment, in the first or second embodiment, the first repeating unit may be a product of a reaction between a carboxylic acid compound having the pyrene group at the terminal and an alcohol compound having a (meth)acrylate group.

According to a fourth embodiment, in any one of the first to third embodiments, the first repeating unit may be represented by the following Formula 1:

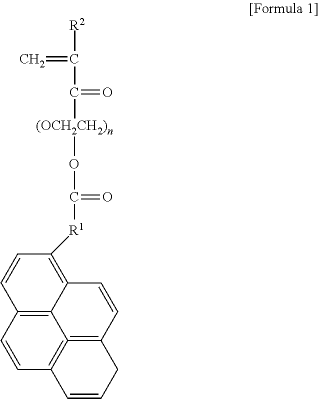

wherein in Formula 1, R¹ is a linker group, an alkylene group having 1 to 10 carbon atoms, a cycloalkylene group having 3 to 10 carbon atoms, or an arylene group having 6 to 20 carbon atoms, R² is hydrogen, an alkyl group having 1 to 10 carbon atoms, a cycloalkyl group having 3 to 10 carbon atoms, or an aryl group having 6 to 20 carbon atoms, and n is an integer from 0 to 1,000,000.

According to a fifth embodiment, in any one of the first to fourth embodiments, the second repeating unit may comprise the following Formula 2:

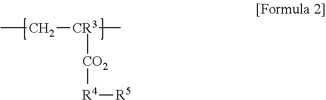

wherein in Formula 2, R³ is hydrogen, an alkyl group having 1 to 10 carbon atoms, a cycloalkyl group having 3 to 10 carbon atoms, or an aryl group having 6 to 20 carbon atoms, R⁴ is a linker group, or an alkylene group having 1 to 10 carbon atoms, a cycloalkylene group having 3 to 10 carbon atoms, or an arylene group having 6 to 20 carbon atoms, R⁵ is —NR⁶R⁷, and each of R⁶ and R⁷ is independently hydrogen, an alkyl group having 1 to 10 carbon atoms, a cycloalkyl group having 3 to 10 carbon atoms, or an aryl group having 6 to 20 carbon atoms.

According to a sixth embodiment, in any one of the first to fifth embodiments, the first repeating unit may be represented by the following Formula 3, and the second repeating unit may be represented by the following Formula 4:

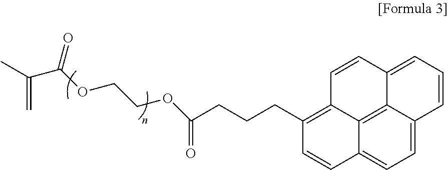

wherein in Formula 3, n is an integer from 1 to 1,000,000,

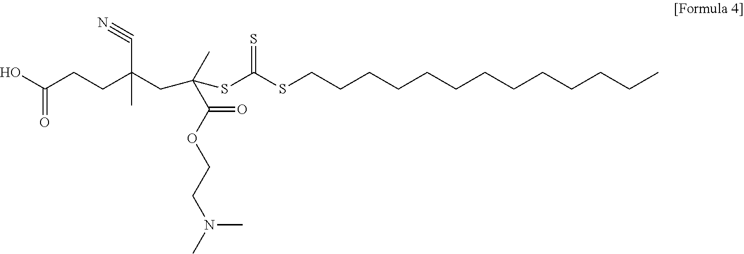 [SMILES: CCCCCCCCCCCCCSC(=S)SC(C)(CC(C)(C#N)CCC(=O)O)C(=O)OCCN(C)C]

wherein in Formula 4, m is an integer from 1 to 1,000,000.

According to a seventh embodiment, there is provided the crosslinked block copolymer, comprising a first block copolymer and a second block copolymer having the same structure as the first block copolymer and crosslinked with the first block copolymer, wherein the first block copolymer is the block copolymer according to any one of the first to sixth embodiments.

According to an eighth embodiment, in the seventh embodiment, the cationic functional group included in the first block copolymer and the cationic functional group included in the second block copolymer may be crosslinked to each other by a crosslinking agent.

According to a ninth embodiment, there is provided the sulfur-carbon composite, comprising a porous carbon material; a coating layer on at least one surface of the porous carbon material, the coating layer comprising the crosslinked block copolymer according to any one of the seventh and eighth embodiments; and a sulfur compound present in at least a portion of the surface of the porous carbon material or inside of pores of the porous carbon material, or a surface of the coating layer.

According to a tenth embodiment, in the ninth embodiment, a weight ratio of the porous carbon material to the crosslinked block copolymer may be 95:5 to 85:15.

According to an eleventh embodiment, in the ninth or tenth embodiment, a weight ratio of the porous carbon material coated with the crosslinked block copolymer to the sulfur compound may be 3:7 to 4:6.

According to a twelfth embodiment, there is provided the lithium-sulfur battery, comprising a positive electrode; a negative electrode; and a separator between the positive electrode and the negative electrode, wherein the positive electrode comprises the sulfur-carbon composite according to any one of the ninth to eleventh embodiments.

According to a thirteenth embodiment, there is provided the method of manufacturing the sulfur-carbon composite, comprising introducing the block copolymer according to any one of the first to sixth embodiments into a dispersion of a porous carbon material to coat the block copolymer on at least a surface of the porous carbon material; crosslinking the block copolymer coated on the porous carbon material to form a crosslinked block copolymer; and loading a sulfur compound into the porous carbon material coated with the crosslinked block copolymer.

According to a fourteenth embodiment, in the thirteenth embodiment, the crosslinked block copolymer may be formed by adding a crosslinking agent to the porous carbon material coated with the block copolymer, and performing thermal treatment.

According to a fifteenth embodiment, in the fourteenth embodiment, the crosslinking agent may comprise a dihalogenoalkane compound.

### Advantageous Effects

The sulfur-carbon composite of the present disclosure comprises the crosslinked block copolymer, and the crosslinked block copolymer is manufactured from the block copolymer comprising the first block comprising the first repeating unit having the pyrene group at the terminal and the second block comprising the second repeating unit having the cationic functional group.

As the crosslinked block copolymer is coated on the sulfur-carbon composite, it may be possible to prevent migration of lithium polysulfide leaking from the positive electrode of the lithium-sulfur battery to the negative electrode. Accordingly, it may be possible to prevent sulfur particle accumulation on the lithium metal surface of the negative electrode, thereby maintaining the charge/discharge capacity of the lithium-sulfur battery, and improving the battery life.

### BRIEF DESCRIPTION OF THE DRAWINGS

The accompanying drawings illustrate exemplary embodiments of the present disclosure and together with the following detailed description, serve to provide a further understanding of the technical aspect of the present disclosure, and thus the present disclosure should not be construed as being limited to the drawings.

FIGS. 1 to 6b show the synthesis mechanism and the synthesized structure of a monomer and a block copolymer prepared in example 1.

FIGS. 7 to 10 are graphs showing discharge capacity of batteries evaluated by charging/discharging at 25° C.

### DETAILED DESCRIPTION

Hereinafter, the present disclosure will be described in more detail.

It should be understood that the terms or words used in the specification and the appended claims should not be construed as limited to general and dictionary meanings, but rather interpreted based on the meanings and concepts corresponding to technical aspects of the present disclosure on the basis of the principle that the inventor is allowed to define terms appropriately for the best explanation.

The term “comprise(s)” or “include(s)” when used in this specification, specifies the presence of stated elements, but does not preclude the presence or addition of one or more other elements, unless the context clearly indicates otherwise.

The term “about” or “approximately” is used herein in the sense of at, or nearly at, when given the manufacturing and material tolerances inherent in the stated circumstances and is used to prevent the unscrupulous infringer from unfairly taking advantage of the present disclosure where exact or absolute figures are stated to help better understanding of the present disclosure.

The present disclosure relates to a block copolymer, a crosslinked block copolymer comprising the block copolymer, a sulfur-carbon composite, a method of manufacturing the sulfur-carbon composite, an electrochemical cell comprising the same and a method of manufacturing the same. In the present disclosure, the electrochemical cell may include any type of battery that generates electrochemical reaction. Specific examples of the electrochemical cell include any type of primary batteries, secondary batteries, fuel cells, solar cells and capacitors such as super capacitors, or the like. In particular, the electrochemical cell may be a secondary battery, and the secondary battery may be a lithium ion secondary battery. The lithium ion secondary battery may include, for example, a lithium-metal battery, a lithium-sulfur battery, an all-solid-state battery, a lithium polymer battery and so on, and among them, a lithium-sulfur battery is preferred.

Among secondary batteries, lithium-sulfur batteries have high discharge capacity and theoretical energy density, and since sulfur used as a positive electrode active material is abundant on Earth and inexpensive, lithium-sulfur batteries require low battery manufacturing costs and are eco-friendly, so they are gaining attention as the next-generation secondary battery.

In the present disclosure, the positive electrode active material comprises a carbon-sulfur composite, and the carbon-sulfur composite comprises a porous carbon material. In the lithium-sulfur battery, since the positive electrode active material, sulfur, is nonconductive, the carbon-sulfur composite, in which a conductive material, for example, a carbon material is combined with sulfur, is commonly used to improve electrical conductivity.

According to an aspect of the present disclosure, there is provided the block copolymer, comprising:
a first block comprising a first repeating unit having a pyrene group at a terminal; and
a second block comprising a second repeating unit having a cationic functional group.

According to an embodiment of the present disclosure, a mole ratio of the first block and the second block may be appropriately selected as required. For example, the mole ratio may be 1:99 to 99:1. Additionally, the weight average molecular weight of the block copolymer may be appropriately selected as required. For example, the weight average molecular weight of the block copolymer may be 10 to 5,000,000.

According to an embodiment of the present disclosure, the first block may originate from the first repeating unit. Additionally, the second block may originate from the second repeating unit.

For example, the first block may be made via chain transfer polymerization of the first repeating unit, and the second block may be made via chain transfer polymerization of the second repeating unit. In this case, the degree of polymerization of each of the first block and the second block may be 10 to 1,000,000.

According to an embodiment of the present disclosure, the first repeating unit may be the result of reaction between a carboxylic acid compound having the pyrene group at the terminal and an alcohol compound having a (meth)acrylate group.

For example, the carboxylic acid compound having the pyrene group at the terminal may be represented by the following Formula 1.

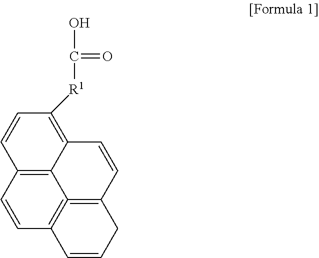

In the above Formula 1, R¹ may be a linker group, an alkylene group having 1 to 10 carbon atoms, a cycloalkylene group having 3 to 10 carbon atoms or an arylene group having 6 to 20 carbon atoms.

For example, the carboxylic acid compound may be 1-pyrenebutyric acid. That is, in the above Formula 1, R¹ may be a propyl group having 3 carbon atoms.

For example, the alcohol compound having the (meth)acrylate group may be represented by the following Formula 2.

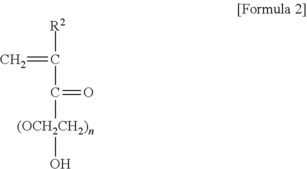

In the above Formula 2, R² may be hydrogen, an alkyl group having 1 to 10 carbon atoms, a cycloalkyl group having 3 to 10 carbon atoms, or an aryl group having 6 to 20 carbon atoms, and n may be an integer from 0 to 1,000,000.

For example, the alcohol compound may be poly(ethylene glycol) methyl ether methacrylate. That is, in the above Formula 2, R² may be hydrogen.

For example, the first repeating unit may be represented by the following Formula 3.

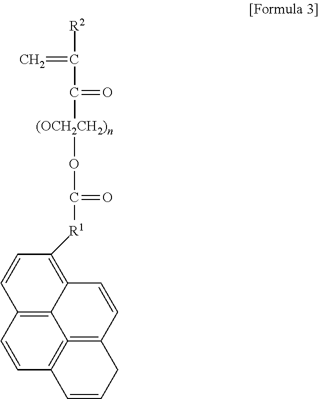

According to an embodiment of the present disclosure, the cationic functional group may comprise a functional group having a nitrogen atom. The cationic functional group may adsorb polysulfide.

According to an embodiment of the present disclosure, the first repeating unit may comprise the following Formula 4.

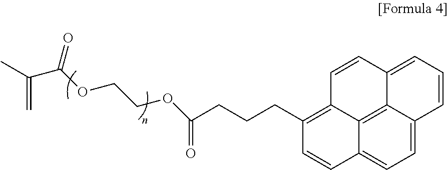

In the above Formula 4, n is an integer from 1 to 1,000,000.

According to an embodiment of the present disclosure, the second repeating unit may comprise the following Formula 5.

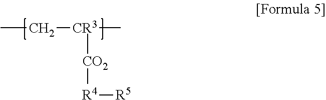

In the above Formula 5, R³ may be hydrogen, an alkyl group having 1 to 10 carbon atoms, a cycloalkyl group having 3 to 10 carbon atoms, or an aryl group having 6 to 20 carbon atoms, R⁴ may be a linker group, or an alkylene group having 1 to 10 carbon atoms, a cycloalkylene group having 3 to 10 carbon atoms, or an arylene group having 6 to 20 carbon atoms, R⁵ may be —NR⁶R⁷, and each of R⁶ and R⁷ may be independently hydrogen, an alkyl group having 1 to 10 carbon atoms, a cycloalkyl group having 3 to 10 carbon atoms, or an aryl group having 6 to 20 carbon atoms.

For example, the second repeating unit may be represented by the following Formula 6.

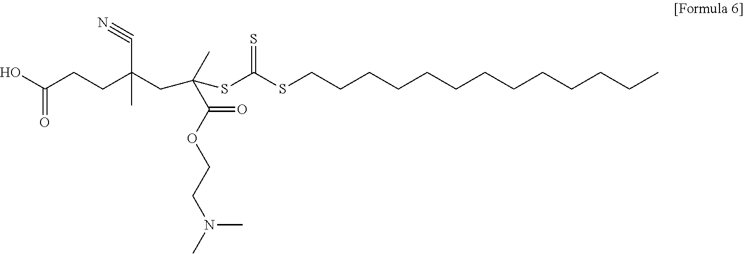

In the above Formula 6, m may be an integer from 0 to 1,000,000.

According to an embodiment of the present disclosure, the block copolymer may be formed by polymerization of the first block and the second block via chain transfer polymerization. For example, after dissolving the first block, the second block, a chain transfer agent (CTA) and a thermal initiator (for example, azobisisobutyronitrile (AIBN)) in a dioxane solvent and removing oxygen in the solution, the polymerization may be performed at high temperature (for example, 80° C.). For example, the chain transfer agent may be 4-cyano-4-(((tridecylthio)carbonothioyl)thio)pentanoic acid. Subsequently, precipitation in diethyl ether and purification may be performed to prepare the block copolymer.

According to an embodiment of the present disclosure, the block copolymer comprising the first block and the second block may be represented by the following Formula 7.

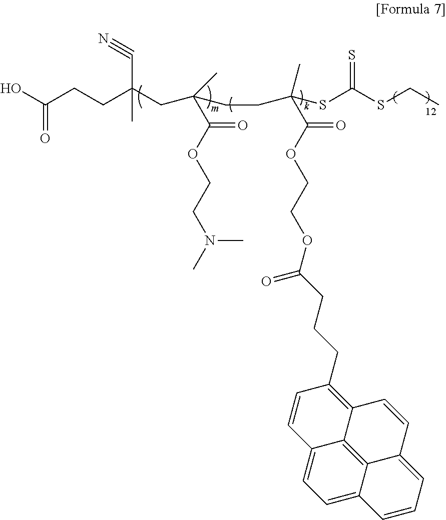

In the above Formula 7, each of m, n and k may be an integer from 0 to 1,000,000.

According to another aspect of the present disclosure, there is provided the crosslinked block copolymer, comprising:
a first block copolymer and a second block copolymer having the same structure as the first block copolymer and crosslinked with the first block copolymer,
wherein the first block copolymer is any one of the above-described block copolymers.

According to an embodiment of the present disclosure, the crosslinked block copolymer may be formed by crosslinking of the first block copolymer and the second block copolymer, and specifically, crosslinking of the cationic functional group of the first block copolymer and the cationic functional group of the second block copolymer by a crosslinking agent. The crosslinking agent is not limited to a particular type, but may comprise, for example, a dihalogenoalkane compound (for example, diiodobutane).

According to another aspect of the present disclosure, there may be the sulfur-carbon composite comprising:
a porous carbon material;
a coating layer on at least one surface of the porous carbon material, the coating layer comprising the above-described crosslinked block copolymer; and
a sulfur compound present in at least a portion of a surface or inside of pores of the porous carbon material, or a surface of the coating layer.

The porous carbon material comprises a platy carbon material, the specific surface area of the porous carbon material is 1,000 m²/g or more, and the pore volume of the porous carbon material is 4 cm³/g or more.

The porous carbon material features high specific surface area to increase active sites of sulfur participating in oxidation/reduction reaction. Additionally, the porous carbon material features high pore volume to ensure high sulfur loading and sufficient ion diffusion paths.

The sulfur-carbon composite comprises the porous carbon material as a host for loading the sulfur containing compound. Specifically, the sulfur-carbon composite comprises a platy porous carbon material as the porous carbon material. The platy porous carbon material may comprise, for example, graphene, graphene oxide, reduced graphene oxide (rGO) or a mixture thereof.

In an embodiment of the present disclosure, the platy porous carbon material may comprise reduced graphene oxide alone.

The porous carbon material has the specific surface area of 1,000 m²/g or more. Specifically, the upper limit of the Brunauer-Emmett-Teller (BET) specific surface area of the porous carbon material is not limited to a particular range, and may be, for example, 1,000 m²/g or more and 1,500 m²/g or less, 1,300 m²/g or less, 1,200 m²/g or less, 1,100 m²/g or less, 1,050 m²/g or less. The sulfur-carbon composite according to the present disclosure comprise a plurality of micropores on the outer surface and/or inside thereof and has a very high specific surface area.

The BET specific surface area may be measured by the BET method, and indicate a value measured by the known method for measuring the BET specific surface area. For example, the BET specific surface area may be a value calculated from the adsorption amount of nitrogen gas under the liquid nitrogen temperature (77K) using BEL Japan's BELSORP-max.

The porous carbon material has the pore volume of 4 cm³/g or more. Specifically, the upper limit of the pore volume of the porous carbon material is not limited to a particular range, and may be, for example, 4 cm³/g or more and 15 cm³/g or less, 6 cm³/g or more and 10 cm³/g or less, 6 cm³/g or more and 8 cm³/g or less, or 6.5 cm³/g or more and 7.5 cm³/g or less. The pore volume may be, for example, a measured value calculated through N2 isotherm analysis obtained based on adsorption of liquid nitrogen.

As described above, the porous carbon material in the sulfur-carbon composite according to an aspect of the present disclosure comprises the plurality of micropores to load the sulfur containing compound.

In an embodiment of the present disclosure, the porous carbon material comprises the plurality of micropores on the outer surface and inside thereof, and in this instance, the micropores comprise meso-pores having the diameter of 1 nm or more and less than 50 nm and macro-pores having the diameter of 50 nm or more and 200 nm or less. In an embodiment of the present disclosure, the porous carbon material preferably has a uniform distribution of the meso-pores and the macro-pores.

The diameter of the micropores may be measured by a method for measuring the pore diameter of porous materials known in the technical field, and the measuring method is not limited to a particular type. For example, the average diameter of the micropores may be measured by scanning electron microscopy (SEM), field emission electron microscopy or a laser diffraction method. The measurement using the laser diffraction method may use, for example, a commercially available laser diffraction particle size measuring instrument (for example, Microtrac MT 3000).

In another embodiment of the present disclosure, the average pore diameter (D50) of the porous carbon material may be, for example, 20 nm to 25 nm, but is not limited thereto. The average diameter (D50) refers to a particle diameter at 50% in cumulative particle size distribution.

In the present disclosure, the sulfur compound is included in at least a portion of the inside of the pores and the outer surface of the porous carbon material having the above-described feature.

The sulfur compound may include, without limitation, any type of sulfur compound that may be used as the positive electrode active material in the lithium-sulfur secondary battery. For example, the sulfur compound may comprise inorganic sulfur (S8), lithium polysulfide (Li₂Sn, 1≤n≤8), carbon sulfur polymer (C₂Sₓ)ₘ, 2.5≤x≤50, 2≤m) or a mixture thereof, but is not limited thereto.

The sulfur compound may be included in the sulfur-carbon composite by physical adsorption onto the porous carbon material, or chemical bonding such as covalent bond, van deer Waals bond, etc. between sulfur and carbon in the porous carbon material.

In an embodiment of the present disclosure, the porous carbon material and the sulfur compound may be, for example, included in the sulfur-carbon composite at a weight ratio of 1:9 to 9:1, and specifically 1:9 to 5:5, 1:9 to 4:6, 1:9 to 3:7 or 1:9 to 1.5:8.5. When the weight ratio of the porous carbon material and the sulfur compound in the sulfur-carbon composite is in the above-described range, since the sulfur compound is included in a large amount, it may be possible to increase the dynamic activity of the sulfur-carbon composite and improve conductivity by the porous carbon material, but the present disclosure is not limited thereto.

In another embodiment of the present disclosure, the amount of the sulfur compound in the sulfur-carbon composite may be, for example, 10 weight % or more, specifically 50 weight % or more, 60 weight % or more, 70 weight % or more, 80 weight % or more, or 85 weight % or more, based on the total weight of the sulfur-carbon composite. Additionally, the amount of the sulfur compound in the sulfur-carbon composite may be 50 weight % to 90 weight %, specifically 60 weight % to 90 weight %, 70 weight % to 90 weight % or 85 weight % to 90 weight % within the above-described range based on the total weight of the sulfur-carbon composite. When the amount of the sulfur compound in the sulfur-carbon composite is in the above-described range, since the sulfur compound is included in a large amount, it may be possible to increase the dynamic activity of the sulfur-carbon composite and improve conductivity by the porous carbon material, but the present disclosure is not limited thereto.

In an embodiment of the present disclosure, the average particle size (D50) of the sulfur-carbon composite may be, for example, 0.5 μm to 200 μm, 0.5 μm to 200 IM, 1 μm to 150 μm, or 10 μm to 150 μm. The particle size of the sulfur-carbon composite may be measured by SEM, field emission electron microscopy or a laser diffraction method. The measurement using the laser diffraction method may use, for example, a commercially available laser diffraction particle size measuring instrument (for example, Microtrac MT 3000). The average particle size (D50) refers to a particle size at 50% in cumulative particle size distribution.

In an embodiment of the present disclosure, the sulfur-carbon composite may have a Raman peak intensity ratio (IG/ID ratio) of 1 or less. For example, when the ratio of IG/ID is larger than 1, due to high surface crystallinity of the sulfur-carbon composite, efficiency in the combination with the sulfur containing compound or conversion reaction of lithium polysulfide may be low, but is not limited thereto.

The Raman peak intensity ratio may be measured through the IG and ID values obtained from the spectrum of the carbon composite obtained via Raman spectroscopy. In the obtained spectrum, IG denotes the peak (G-peak, 1573/cm) of a crystalline portion, and ID denotes the peak (D-peak, 1309/cm) of an amorphous portion. Accordingly, in this instance, the smaller ratio value of IG/ID, the lower crystallinity.

In an embodiment of the present disclosure, the sulfur-carbon composite may be formed by mixing the porous carbon material with the sulfur compound and performing thermal treatment, but the manufacturing method of the present disclosure is not limited thereto.

Since the sulfur-carbon composite of the present disclosure as described above comprises the platy carbon material having high specific surface area and high pore volume, it may be possible to enhance sulfur loading and provide a plurality of active sites of oxidation/reduction reaction of sulfur, thereby improving battery efficiency and energy density when used in the positive electrode of the lithium-sulfur battery, but the mechanism of the present disclosure is not limited thereto.

In an embodiment of the present disclosure, the coating layer may comprise the above-described crosslinked block copolymer. For example, a weight ratio of the porous carbon material and the crosslinked block copolymer may be 95:5 to 85:15. Additionally, the weight ratio of the porous carbon material coated with the crosslinked block copolymer and the sulfur compound may be 3:7 to 4:6.

According to another aspect of the present disclosure, there is provided the method of manufacturing the sulfur-carbon composite, comprising:
introducing the above-described block copolymer into a dispersion of the porous carbon material to coat the block copolymer on at least one surface of the porous carbon material;
crosslinking the block copolymer coated on the porous carbon material to form a crosslinked block copolymer; and
loading sulfur into the porous carbon material coated with the crosslinked block copolymer.

In an embodiment of the present disclosure, the porous carbon material (for example, ketjen black (KB)) and chloride (for example, FeCl₃) may be dispersed in a solvent. For example, the solvent is not limited to a particular type and may include any type of solvent capable of dissolving or dispersing compounds. The solvent may be, for example, a chlorine-based solvent such as chloroform, methylene chloride, 1,2-dichloroethane, 1,1,2-trichloroethane, chlorobenzene, o-dichlorobenzene; an ether-based solvent such as tetrahydrofuran, dioxane; an aromatic hydrocarbon-based solvent such as toluene, xylene, trimethylbenzene, mesitylene; an aliphatic hydrocarbon-based solvent such as cyclohexane, methylcyclohexane, n-pentane, n-hexane, n-heptane, n-octane, n-nonane, n-decane; a ketone-based solvent such as acetone, methylethylketone, cyclohexanone; an ester-based solvent such as ethyl acetate, butyl acetate, ethyl cellosolve acetate; a multivalent alcohol such as ethyleneglycol, ethyleneglycolmonobutylether, ethyleneglycolmonoethylether, ethyleneglycolmonomethylether, dimethoxyethane, propyleneglycol, diethoxy methane, triethyleneglycolmonoethylether, glycerin, 1,2-hexanediol and its derivatives; an alcohol-based solvent such as methanol, ethanol, propanol, isopropanol, cyclohexanol; a sulfoxide-based solvent such as dimethylsulfoxide; an amide-based solvent such as N-methyl-2-pyrrolidone, N,N-dimethylformamide; a benzoate-based solvent such as butylbenzoate, methyl-2-methoxybenzoate; tetralin; 3-phenoxy-toluene.

Subsequently, after the above-described block copolymer is introduced into the dispersion of the porous carbon material, coating may be performed at room temperature for 24 hours. For example, the weight ratio of the porous carbon material and the block copolymer may be 95:5 to 85:15.

Subsequently, the crosslinking agent (for example, a dihalogenoalkane compound such as diiodobutane) was added to the dispersion of the porous carbon material coated with the block copolymer, and thermally treated at approximately 45° C. for 24 hours to crosslink the block copolymer in the porous carbon material.

Subsequently, the sulfur compound may be loaded into the porous carbon material coated with the crosslinked block copolymer and thermally treated to make the sulfur-carbon composite. For example, the weight ratio of the porous carbon material coated with the crosslinked block copolymer and the sulfur compound may be 3:7 to 4:6.

Since the crosslinked block copolymer is coated on the porous carbon material, it may be possible to prevent migration of lithium polysulfide leaking from the positive electrode of the lithium-sulfur battery to the negative electrode. Accordingly, it may be possible to prevent sulfur particle accumulation on the lithium metal surface of the negative electrode, thereby maintaining the charge/discharge capacity of the lithium-sulfur battery and improving the battery life.

Hereinafter, examples will be described in detail to help better understanding of the present disclosure. However, the examples according to the present disclosure may be modified in many other forms, and the scope of the present disclosure should not be interpreted as being limited to the following examples. The examples of the present disclosure are provided to fully explain the present disclosure to persons having ordinary skill in the art.

### Example 1

### Preparation of Block Copolymer

1) Preparation of first monomer: 1-pyrenebutyric acid (PBA) and poly(ethylene glycol) methyl ether methacrylate (PEGMA) were subjected to reaction in a toluene solvent under a p-Toluenesulfonic acid (pTsOH) catalyst at 110° C. to synthesize PEGMA-PBA (hereinafter referred to as PP). The synthesized PP was purified through H₂O/MC (methylene chloride) extraction carried out 3 times.

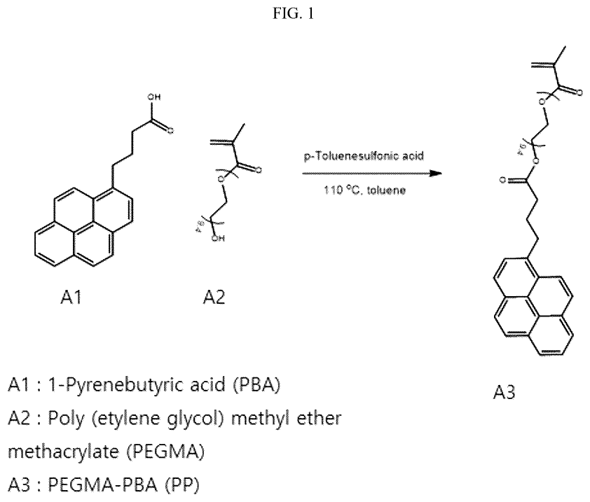

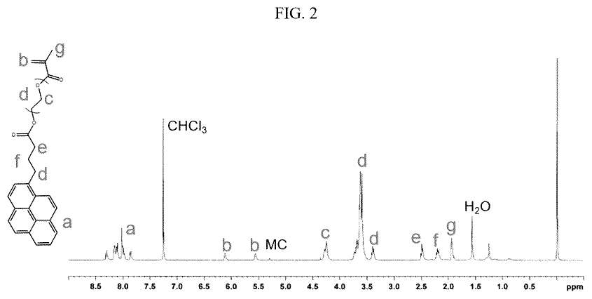

The detailed synthesis mechanism is depicted in FIG. 1, and the structure of the synthesized monomer was seen through ¹H NMR and the results are shown in FIG. 2.

2) Preparation of second monomer: dimethyl amino ethyl acrylate (DMAEMA), a chain transfer agent (CTA, 4-cyano-4-(((tridecylthio)carbonothioyl)thio)pentanoic acid) and AIBN were dissolved in a dioxane solvent and undergone three freeze-pump-thaw cycles to remove oxygen in the solution. The oxygen free solution undergone polymerization at 80° C. The polymerized crude product was purified through precipitation in hexane carried out 3 times, yielding poly(dimethyl-amino) ethyl methacrylate (PDMAEMA).

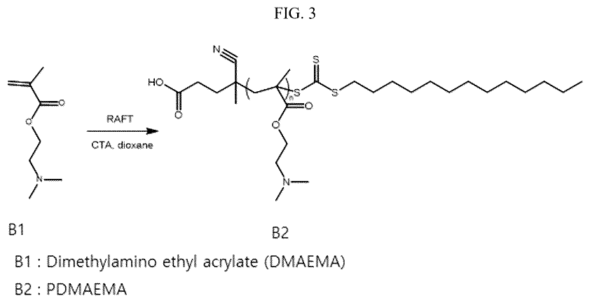

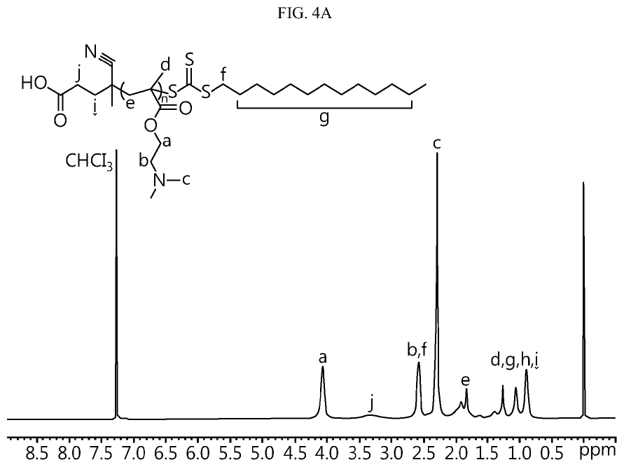

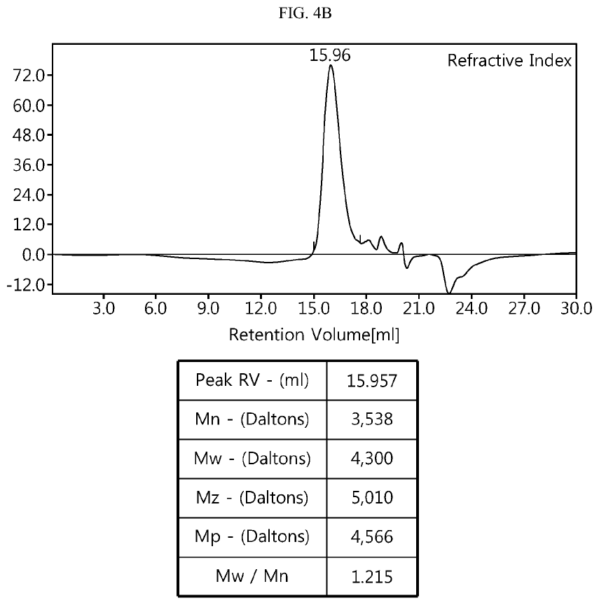

The detailed synthesis mechanism is depicted in FIG. 3, the structure of the synthesized monomer was seen through ¹H NMR, GPC analysis, and the results are shown in FIG. 4A and FIG. 4A.

3) Preparation of block copolymer: the first monomer and the second monomer (first monomer:second monomer=1:1, mole ratio basis) prepared as described above, CTA(4-cyano-4-(((tridecylthio)carbonothioyl)thio)pentanoic acid) and AIBN were dissolved in a dioxane solvent and undergone three freeze-pump-thaw cycles to remove oxygen in the solution. The oxygen fee solution undergone polymerization at 80° C. The polymerized crude product was purified through precipitation in diethyl ether carried out 3 times, yielding PDbPP.

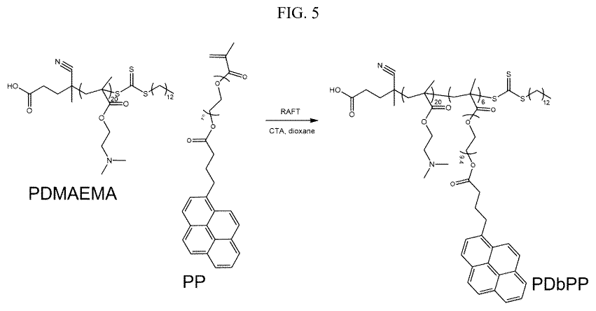

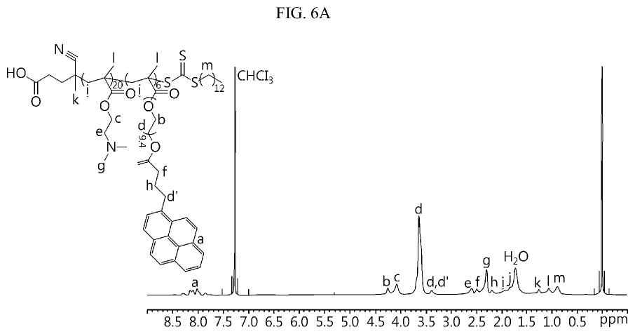

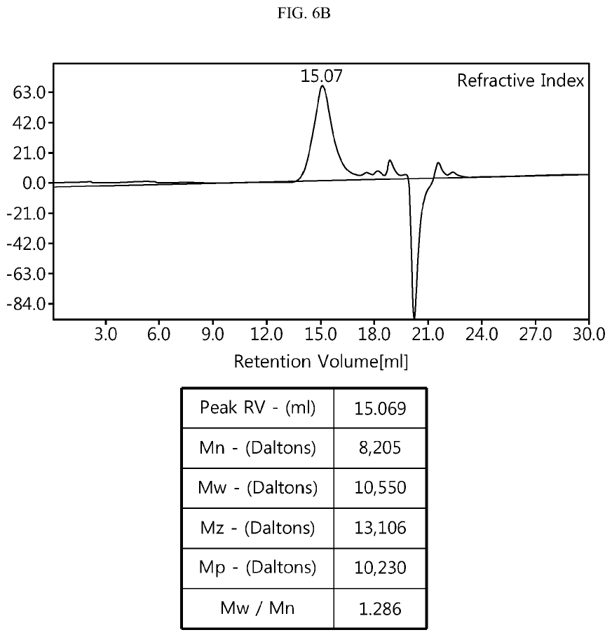

The detailed synthesis mechanism is depicted in FIG. 5, the structure of the synthesized PDbPP was seen through ¹H NMR, GPC analysis, and the results are shown in FIG. 6A and FIG. 6B.

### Preparation of Sulfur-Carbon Composite

1) dispersing ketjen black (KB) and FeCl3 in a chloroform solvent by sonication for 3 hours.
2) dissolving PDbPP (10 wt % compared to KB) in chloroform, adding to the dispersion of KB dropwise and stirring at room temperature for 24 hours to form a coating.
3) adding diiodobutane to the dispersion of KB coated with PDbPP dropwise and causing reaction at 45° C. for 24 hours to crosslink the coated PDbPP, yielding CPDbPP10-KB.
4) pulverizing and mixing CPDbPP10-KB and sulfur (CPDbPP10-KB:S=7:3, w/w) and thermally treating at 155° C. for 30 minutes to load sulfur, yielding CPDbPP10-KB-S.

### Positive Electrode

A sulfur compound was loaded into ketjen black coated with the crosslinked block copolymer as a positive electrode active material to make a sulfur-carbon composite (CPDbPP10-KB-S).

The sulfur-carbon composite, a PAA binder (poly(acrylic acid)) and a carbon conductive material were mixed at a weight ratio of 85:10:5, and 0.5 wt % of PVA dispersant was added to prepare a positive electrode slurry with the solid concentration of 18 wt %, and the positive electrode slurry was uniformly coated on an aluminum foil to the thickness of 400 μm and dried at 50° C. to make a positive electrode. The weight ratio of the crosslinked block copolymer to the positive electrode was 8.5 wt %.

### Separator, Negative Electrode and Electrolyte

For a separator, a polyethylene porous film (Celgard separator) was used, and for a negative electrode, lithium metal was used. 1.0 M LiNO₃ was added to a mixed solvent of 1,3-dioxolane (DOL) and 1,2-dimethylether at a volume ratio (v/v) of 50:50 to prepare an electrolyte solution for a lithium-sulfur secondary battery.

### Comparative Example 1

### Positive Electrode

A positive electrode was prepared by the same method as example 1 except that the sulfur-carbon composite in which ketjen black and the sulfur compound were mixed at the weight ratio 3:7 was used as the positive electrode active material.

### Separator, Negative Electrode and Electrolyte

A separator, a negative electrode and an electrolyte were prepared by the same method as example 1.

### Comparative Example 2

### Positive Electrode

(1) a sulfur compound was loaded into ketjen black as a positive electrode active material, (2) a block copolymer was coated on the sulfur compound loaded ketjen black, (3) the block copolymer was crosslinked to prepare a sulfur-carbon composite comprising a crosslinked block copolymer. The sulfur-carbon composite, a PAA binder, and a carbon conductive material were mixed at a weight ratio of 85:10:5, 0.5 wt % of PVA dispersant was added to prepare a positive electrode slurry with solid concentration of 18 wt %, and the positive electrode slurry was uniformly coated on an aluminum foil to the thickness of 400 μm and dried at 50° C. to prepare a positive electrode. A weight ratio of the crosslinked block copolymer to the positive electrode was 3 wt %.

### Separator, Negative Electrode and Electrolyte

A separator, a negative electrode and an electrolyte were prepared by the same method as example 1.

### Comparative Example 3

### Positive Electrode

A positive electrode was prepared by the same method as comparative example 2, except that the ketjen black coated with the crosslinked block copolymer and the sulfur compound were mixed at the weight ratio of 1:9 (CPDbPP10-KB:S=1:9, w/w).

### Separator, Negative Electrode and Electrolyte

A separator, a negative electrode and an electrolyte were prepared by the same method as example 1.

### Comparative Example 4

### Positive Electrode

A positive electrode was prepared by the same method as comparative example 2, except that the weight ratio of the crosslinked block copolymer to the positive electrode was 1 wt %.

### Separator, Negative Electrode and Electrolyte

A separator, a negative electrode and an electrolyte were prepared by the same method as example 1.

### Comparative Example 5

### Positive Electrode

A positive electrode was prepared by the same method as comparative example 2, except that the weight ratio of the crosslinked block copolymer to the positive electrode was 5 wt %.

### Separator, Negative Electrode and Electrolyte

A separator, a negative electrode and an electrolyte were prepared by the same method as example 1.

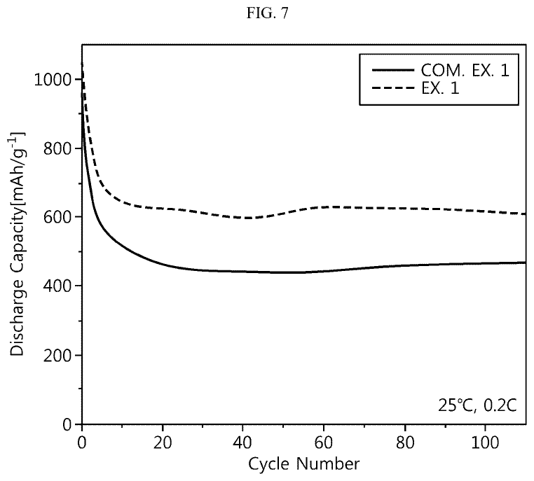

FIG. 7 is a graph showing discharge capacity evaluated by charging/discharging at 25° C. in the following conditions.
Tester: WBSC3000 battery cycler (WonAtech)
Current density: 0.2 C-rate

Referring to FIG. 7, the lithium-sulfur battery according to example 1 had higher discharge capacity than the lithium-sulfur battery according to comparative example 1 for 1 cycle to 100 cycles when measured.

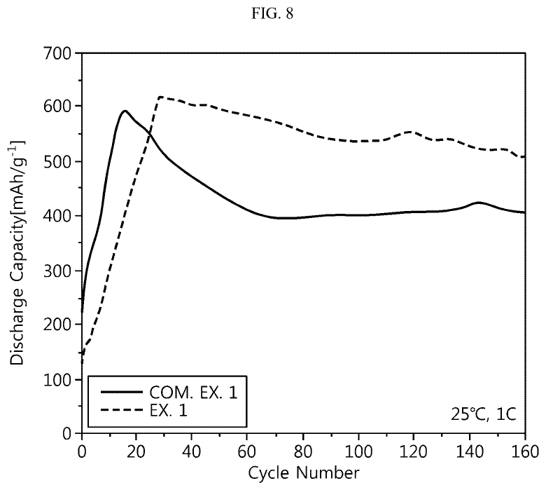

FIG. 8 is a graph showing discharge capacity evaluated by charging/discharging at 25° C. in the following conditions.
Tester: WBSC3000 battery cycler (WonAtech)
Current density: 1 C-rate

Referring to FIG. 8, the lithium-sulfur battery according to example 1 had higher discharge capacity than the lithium-sulfur battery according to comparative example 1 for 40 cycles to 160 cycles when measured.

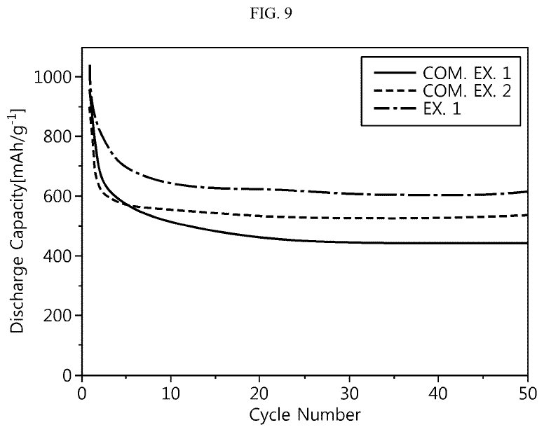

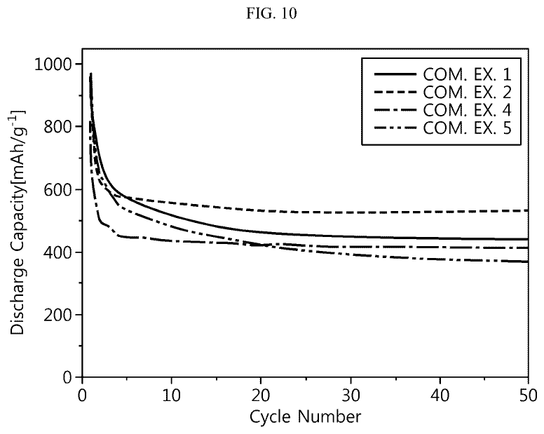

FIGS. 9 and 10 are graphs showing discharge capacity evaluated by charging/discharging at 25° C. in the following conditions.
Tester: WBSC3000 battery cycler (WonAtech)
Current density: 0.2 C-rate

Referring to FIGS. 9 and 10, as can be seen from FIG. 9, the lithium-sulfur battery according to example 1 had higher discharge capacity than the lithium-sulfur batteries according to comparative examples 1 and 2 for 1 cycle to 50 cycles when measured.

In other words, the measurements revealed that compared to not forming the coating layer or forming the coating layer after sulfur loading, forming the coating layer on the porous carbon material and then loading the sulfur compound contributed to improved coating of the coating layer, thereby achieving high discharge capacity.

Meanwhile, referring to FIG. 10, it was confirmed that comparative example 2 had higher discharge capacity than comparative examples 1, 4 and 5, but as can be seen from FIG. 9, comparative example 2 was poorer than example 1 in which the coating layer was first formed and then the sulfur compound was loaded.

1. A block copolymer, comprising:
a first block comprising a first repeating unit having a pyrene group at a terminal; and
a second block comprising a second repeating unit having a cationic functional group.

2. The block copolymer according to claim 1,
wherein a mole ratio of the first block to the second block is 1:99 to 99:1.

3. The block copolymer according to claim 1, wherein the first repeating unit is a product of a reaction between a carboxylic acid compound having the pyrene group at the terminal and an alcohol compound having a (meth)acrylate group.

4. The block copolymer according to claim 1, wherein the first repeating unit is represented by the following Formula 1: 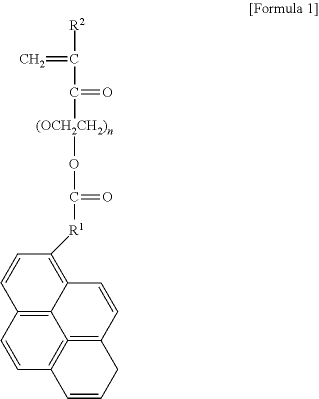
wherein in Formula 1, R¹ is a linker group, an alkylene group having 1 to 10 carbon atoms, a cycloalkylene group having 3 to 10 carbon atoms, or an arylene group having 6 to 20 carbon atoms, R² is hydrogen, an alkyl group having 1 to 10 carbon atoms, a cycloalkyl group having 3 to 10 carbon atoms, or an aryl group having 6 to 20 carbon atoms, and n is an interform 0 to 1,000,000.

5. The block copolymer according to claim 1, wherein the second repeating unit comprises the following Formula 2: 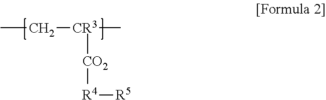
wherein in Formula 2, R³ is hydrogen, an alkyl group having 1 to 10 carbon atoms, a cycloalkyl group having 3 to 10 carbon atoms, or an aryl group having 6 to 20 carbon atoms, R⁴ is a linker group, or an alkylene group having 1 to 10 carbon atoms, a cycloalkylene group having 3 to 10 carbon atoms, or an arylene group having 6 to 20 carbon atoms, R⁵ is —NR⁶R⁷, and each of R⁶ and R⁷ is independently hydrogen, an alkyl group having 1 to 10 carbon atoms, a cycloalkyl group having 3 to 10 carbon atoms, or an aryl group having 6 to 20 carbon atoms.

6. The block copolymer according to claim 1, wherein the first repeating unit is represented by the following Formula 3, and
wherein the second repeating unit is represented by the following Formula 4: 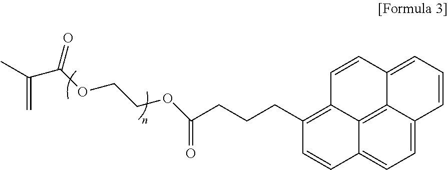
wherein in Formula 3, n is an integer from 1 to 1,000,000, 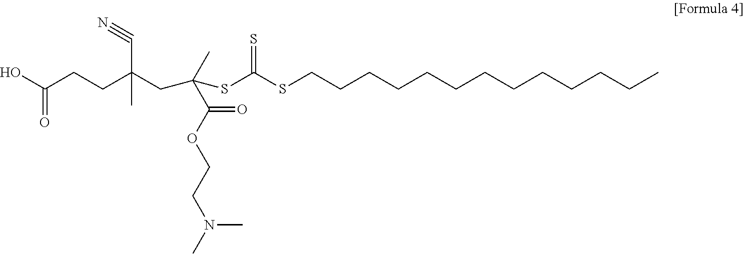 [SMILES: CCCCCCCCCCCCCSC(=S)SC(C)(CC(C)(C#N)CCC(=O)O)C(=O)OCCN(C)C]
wherein in Formula 4, m is an integer from 1 to 1,000,000.

7. A crosslinked block copolymer, comprising:
a first block copolymer; and
a second block copolymer having the same structure as the first block copolymer and crosslinked with the first block copolymer,
wherein the first block copolymer is the block copolymer according to claim 1.

8. The crosslinked block copolymer according to claim 7, wherein the cationic functional group included in the first block copolymer and the cationic functional group included in the second block copolymer are crosslinked to each other by a crosslinking agent.

9. A sulfur-carbon composite, comprising:
a porous carbon material;
a coating layer on at least a surface of the porous carbon material, the coating layer comprising the crosslinked block copolymer according to claim 7; and
a sulfur compound present in at least a portion of the surface of the porous carbon material or inside of pores of the porous carbon material, or a surface of the coating layer.

10. The sulfur-carbon composite according to claim 9, wherein a weight ratio of the porous carbon material to the crosslinked block copolymer is 95:5 to 85:15.

11. The sulfur-carbon composite according to claim 9, wherein a weight ratio of the porous carbon material coated with the crosslinked block copolymer to the sulfur compound is 3:7 to 4:6.

12. A lithium-sulfur battery, comprising:
a positive electrode;
a negative electrode; and
a separator between the positive electrode and the negative electrode,
wherein the positive electrode comprises the sulfur-carbon composite according to claim 9.

13. A method of manufacturing a sulfur-carbon composite, comprising:
introducing the block copolymer according to claim 1 into a dispersion of a porous carbon material to coat the block copolymer on at least a surface of the porous carbon material;
crosslinking the block copolymer coated on the porous carbon material to form a crosslinked block copolymer, and
loading a sulfur compound into the porous carbon material coated with the crosslinked block copolymer.

14. The method of manufacturing the sulfur-carbon composite according to claim 13, wherein the crosslinked block copolymer is formed by adding a crosslinking agent to the porous carbon material coated with the block copolymer, and performing thermal treatment.

15. The method of manufacturing the sulfur-carbon composite according to claim 14, wherein the crosslinking agent comprises a dihalogenoalkane compound.
